(19) United States
(12) Patent Application Publication
(10) Pub. No.: US 2011/0085505 A1
(43) Pub. Date: Apr. 14, 2011

(54) METHOD FOR PRODUCING COMMUNICATION FRAME OF BODY AREA NETWORK AND COMMUNICATION NETWORK OF BODY AREA NETWORK USING THE SAME

(75) Inventors: Tae Young KANG, Daejeon (KR); Sung Weon Kang, Daejeon (KR); Tae Wook Kang, Daejeon (KR); Kyung Soo Kim, Daejeon (KR); Sung Eun Kim, Seoul (KR); Jung Bum Kim, Daejeon (KR); Kyung Hwan Park, Daejeon (KR); Hyung Il Park, Daejeon (KR); In Gi Lim, Daejeon (KR); Byoung Gun Choi, Daejeon (KR); Seok Bong Hyun, Daejeon (KR); Chang Hee Hyoung, Daejeon (KR); Jung Hwan Hwang, Daejeon (KR)

(73) Assignee: Electronics and Telecommunications Research Institute, Daejeon (KR)

(21) Appl. No.: 12/902,121

(22) Filed: Oct. 11, 2010

(30) Foreign Application Priority Data
Oct. 12, 2009 (KR) 10-2009-0096957
Oct. 4, 2010 (KR) 10-2010-0096343

(51) Int. Cl. H04W 8/02

(52) U.S. Cl. 370/329

(57) ABSTRACT

A method for generating a communication frame of a body area network, includes: recognizing the number of terminals existing within a predetermined area; allocating an individual frame to be used by each of the terminals existing within the predetermined area according to the recognized number of terminals; and allocating a coexistence frame to be transmitted to every terminal existing within the predetermined area according to the recognized number of terminals.

### CROSS-REFERENCE TO RELATED APPLICATIONS

This application claims the priority of Korean Patent Application Nos. 10-2009-0096957 filed on Oct. 12, 2009 and 10-2010-0096343 filed on Oct. 4, 2010, in the Korean intellectual Property Office, the disclosures of which are incorporated herein by reference.

### BACKGROUND OF THE INVENTION

1. Field of the Invention

The present invention relates to a method for generating a communication frame of a body area network and a communication method of a body area network using the same, and more particularly, to a method for generating a communication frame of a body area network allowing adjacent body area network terminals to communicate with each other without causing interference therebetween.

The present invention is derived from research conducted as a part of IT growth power industrial technology development work supported by the IT R&D program of MIC/IITA and the Knowledge Economics Department [Project Management No.: 2008-S-072-04, Project title: Human Body communication Controller Soc].

2. Description of the Related Art

In general, human body communication, which refers to a communication scheme in which data is transmitted as a current directly flows between terminals attached to human bodies, uses a baseband signal of 30 MHz or lower without using a carrier, and is utilized for high speed radio communication of hundreds of kbps to tens of Mbps, according to modulation schemes.

When the baseband signal is lower than 30 MHz, the characteristics of the signal which is transmitted between the terminals through human bodies are excellent, yet when the baseband signal is higher than 30 MHz, human bodies act like dielectric antennas to increase a signal component radiated to outside of the human bodies compared with a signal transmitted through the human bodies.

Thus, human body communication largely uses a baseband signal of 30 MHz or lower, in order to increase the proportion of the signal component of a transmission signal received by another communication device through a human body compared with the signal component of the transmission signal radiated through the human body. In this case, the signal radiated to the outside of the human body is very small so the communication devices attached to the users' human bodies can smoothly transmit and receive data transferred therebetween.

However, when the human body communication users are in close proximity to each other in a restricted area such as subway, an elevator, and the like, a phenomenon in which mutual data transmissions collide occurs due to a slight radiation of baseband signals, paralyzing communications.

Thus, in order to solve the communication paralysis phenomenon, a method for enabling the communication equipment of different users to coexist as well as synchronizing the human body communication devices of users is required.

### SUMMARY OF THE INVENTION

An aspect of the present invention provides a method for generating a communication frame of a body area network.

Another aspect of the present invention provides a communication method of a body area network using a method for generating a communication frame of a body area network.

According to an aspect of the present invention, there is provided a method for generating a communication frame of a body area network, including: recognizing the number of terminals existing within a predetermined area; allocating an individual frame to be used by each of the terminals existing within the predetermined area according to the recognized number of terminals; and allocating a coexistence frame to be transmitted to every terminal existing within the predetermined area according to the recognized number of terminals.

The coexistence frame may include information regarding the allocation of the individual frame to be used by each of the terminals existing within the predetermined area.

The coexistence frame may use any one of radio frequency identification (RFID), Bluetooth™, ZigBee™, and ultra-wide band (UWB).

The individual frame may be used for each of the terminals to communicate with a sub-terminal.

The coexistence frame may reach a more extensive area than that of the individual frame.

The coexistence frame may include: a preamble; and a group ID identifying a group of terminals within a predetermined area.

The coexistence frame may further include: a terminal ID identifying each of the terminals of the group.

According to another aspect of the present invention, there is provided a communication method of a body area network, including: generating a communication frame to be transmitted to a terminal existing within a predetermined area; providing information regarding the generated communication frame to the terminal existing within the predetermined area; and utilizing, by the terminal which has received information regarding the generated communication frame, the generated communication frame.

The generating of the communication frame may include: recognizing the number of terminals existing within the predetermined area; allocating an individual frame to be used by each of the terminals existing within the predetermined area according to the recognized number of terminals; and allocating a coexistence frame to be transmitted to every terminal existing within the predetermined area according to the recognized number of terminals.

The coexistence frame may include information regarding the allocation of the individual frame to be used by each of the terminals existing within the predetermined area.

The coexistence frame may use any one of radio frequency identification (RFID), Bluetooth™, ZigBee™, and ultra-wide band (UWB).

The individual frame may be used for each of the terminals to communicate with a sub-terminal.

The coexistence frame may reach a more extensive area than that of the individual frame.

In providing information regarding the generated communication frame to the terminal existing within the predetermined area, the information regarding the generated communication frame may be provided by using the coexistence frame.

In utilizing the generated communication frame by the terminal which has received the information regarding the generated communication frame, the terminal uses the individual frame.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the case in which a single terminal exists in a body area network according to an exemplary embodiment of the present invention;

FIG. 2 is a view illustrating the case in which two terminals exist in a body area network according to an exemplary embodiment of the present invention;

FIG. 3 is a flow chart illustrating a process of a method for generating a communication frame of a body area network according to an exemplary embodiment of the present invention;

FIG. 4 is a view illustrating the case in which four terminals exist in a body area network according to an exemplary embodiment of the present invention;

FIG. 5 is a view illustrating an example of a coexistence frame in the method of generating a communication frame of a body area network according to an exemplary embodiment of the present invention;

FIG. 6 is a view illustrating another example of a coexistence frame in the method of generating a communication frame of a body area network according to an exemplary embodiment of the present invention;

FIG. 7 is a flow chart illustrating the process of a communication method of a body area network using the method for generating a communication frame of a body area network according to an exemplary embodiment of the present invention; and

FIG. 8 is a view illustrating the communication method of a body area network using the method for generating a communication frame of a body area network according to an exemplary embodiment of the present invention.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components that are the same or are in correspondence are rendered using the same reference number, regardless of the figure number, and redundant explanations are omitted.

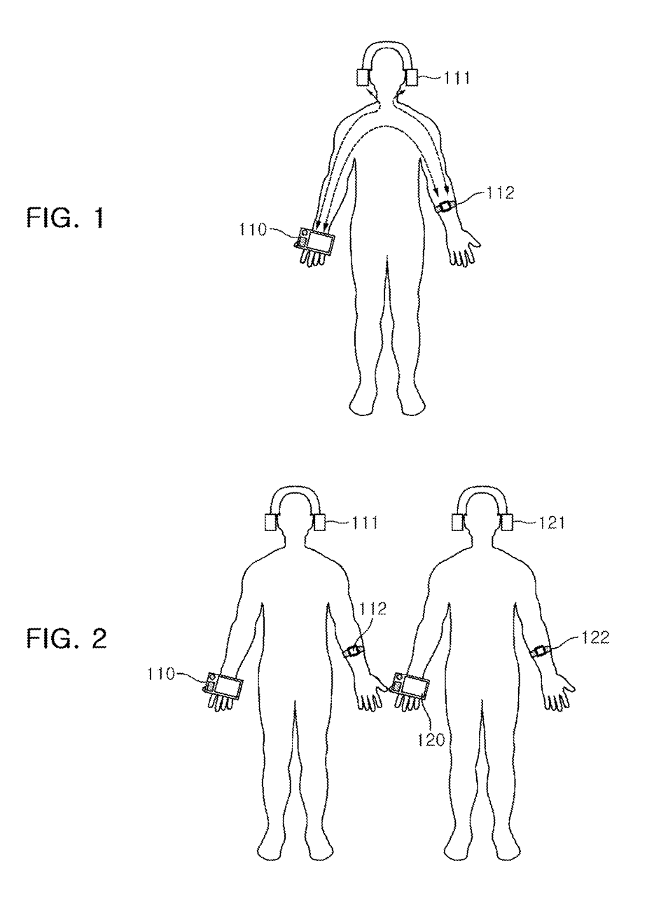

FIG. 1 is a view illustrating the case in which a single terminal exists in a body area network according to an exemplary embodiment of the present invention.

With reference to FIG. 1, a terminal of a body communication system uses a user's body as a communication channel. When two or more types of communication equipment exist, one type of communication equipment is set as a terminal (or a master terminal), and the other types of equipment are configured as sub-terminals (or slave terminals).

For example, when a portable communication device 110 is configured as a master terminal and a headset 111 and a medical terminal 112 are configured as sub-terminals (or slave terminals), the portable communication device 110 manages the transmission and reception of data transferred through the user's body. Also, when the portable communication device is a mobile phone, it performs a voice call with an external terminal, transmits and receives data, and controls the sub-terminals (slave terminals) to be added for human body communication or excluded from human body communication.

FIG. 2 is a view illustrating the case in which two terminals exist in a body area network according to an exemplary embodiment of the present invention.

With reference to FIG. 2, when another user approaches to become close to the human body communication user while the human body communication user performs human body communication, the two human body communication systems affect each other due to radiation of a slight baseband signal.

When the terminals attached to the two users are mobile communication terminals such as mobile phones, they are able to use synchronized clocks through communication with a base station and restore a human body communication signals within each user by using the synchronized clocks.

However, when the terminal (or the master terminal) attached to each of the human body communication users is not a mobile communication terminal, data transmitted by the respective terminals may affect other data, resulting in communication faults.

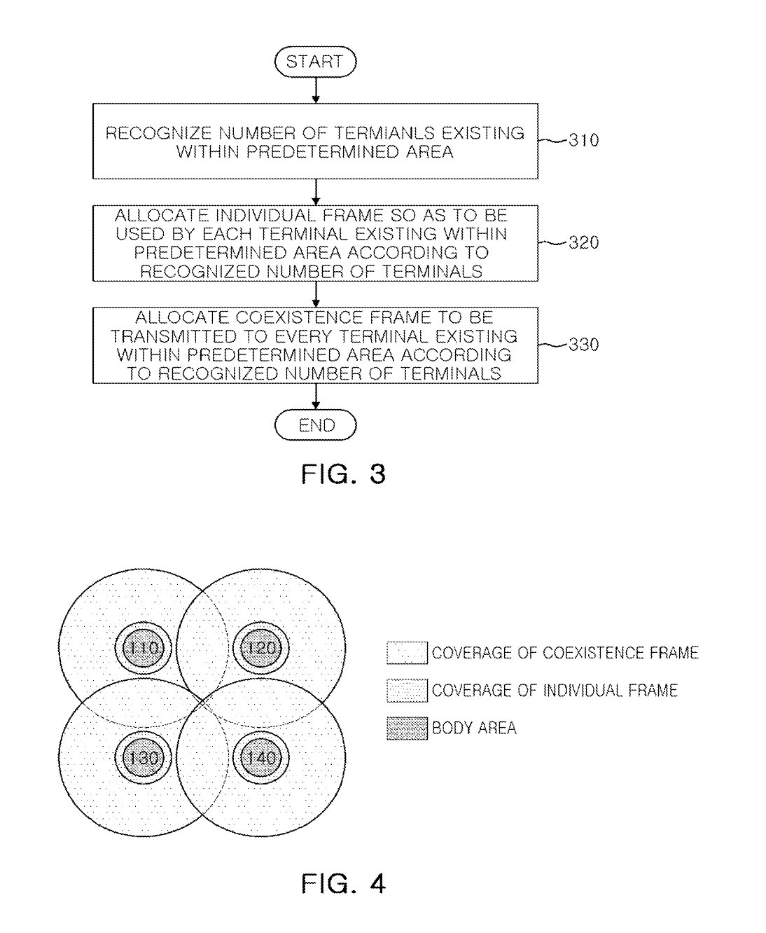

FIG. 3 is a flow chart illustrating a process of a method for generating a communication frame of a body area network according to an exemplary embodiment of the present invention.

With reference to FIG. 3, a method for generating a communication frame of a body area network according to an exemplary embodiment of the present invention may include recognizing the number of terminals existing within a predetermined area (step 310), allocating an individual frame to be used by each of the terminals existing within the predetermined area according to the recognized number of terminals (step 320), and allocating a coexistence frame to be transmitted to every terminal existing within the predetermined area according to the recognized number of terminals (step 330).

First, in recognizing the number of terminals existing within the predetermined area (step 310), it may be determined how many terminals exist within the predetermined area. Namely, the number of terminals is recognized, and the recognized number of terminals may be reflected in allocating frames in a follow-up step.

Next, in allocating an individual frame to be used by each of the terminals existing within the predetermined area according to the recognized number of terminals (step 320), individual frames equal to the number of the terminals may be allocated to allow the terminal to use the individual frames, respectively.

For example, when the recognized number of terminals is six, six individual frames must be allocated to the six terminals to allow all of the six terminals to have an individual frame, independently. Namely, six individual frames are allocated to fit the number 6, the recognized number of the terminals.

Here, the individual frames may be used by the terminals when the terminals communicate with their sub-terminals. Namely, the respective terminals and their sub-terminals are able to freely communicate with each other without being interrupted by any other terminals.

In allocating the coexistence frame to be transmitted to every terminal existing within the predetermined area according to the recognized number of terminals (step 330), information regarding each of the individual frames allocated according to the number of the terminals may be provided to allow each of the terminals to know about the information.

Here, the coexistence frame may include information regarding the allocation of the individual frames, to be used by the respective terminals, to the respective terminals existing within the predetermined area. Also, the coexistence frame may use any one of radio frequency identification (RFID), Bluetooth™ ZigBee™, and ultra-wide band (UWB). Also, the coexistence frame may reach a more extensive area than that of the individual frames.

Namely, the coexistence frame has a transmission coverage within which the coexistence frame able to be transmitted to every terminal within the predetermined area, so the coexistence frame is able to provide information regarding the allocation of the individual frames to be used by the respective terminals to all the terminals within the predetermined area.

Thus, the coexistence frame may be transmitted by using any one of the radio frequency identification (RFID), Bluetooth™, ZigBee™, and ultra-wide band (UWB).

FIG. 4 is a view illustrating the case in which four terminals exist in a body area network according to an exemplary embodiment of the present invention.

As shown in FIG. 4, four terminals are grouped in the body area network. When two or more human body communication terminals are located in close proximity to each other, the users' terminals may need to set a usage time to transmit or receive data in order to avoid a communication fault potentially caused by a data collision.

With reference to FIG. 4, the coverage of the coexistence frame may be set such that every terminal within the predetermined area can receive the coexistence frame within the coverage of the coexistence frame. The coexistence frame is transmitted by using a high clock frequency. Thus, the coexistence frame has the advantage in that it is able to be transferred to a user who is located outside of the coverage of a baseband signal used by the individual frames, and recognizes a different user before transmission and reception data between users collides.

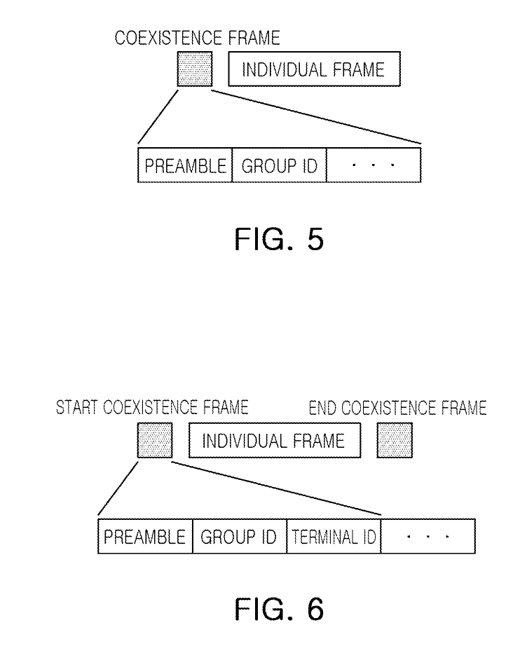

FIG. 5 is a view illustrating an example of a coexistence frame in the method of generating a communication frame of a body area network according to an exemplary embodiment of the present invention. FIG. 6 is a view illustrating another example of a coexistence frame in the method of generating a communication frame of a body area network according to an exemplary embodiment of the present invention.

With reference to FIGS. 5 and 6, the coexistence frame may include a preamble, and a group ID identifying a group of terminals within a predetermined area. In addition, the coexistence frame may further include a terminal ID identifying each of the terminals of the group.

Namely, the coexistence frame includes a preamble allowing for a detection of the coexistence frame and a group ID of a group to which the terminals existing within a predetermined area belongs. Thus, upon receiving the coexistence frame, a terminal can be aware of a group to which it belongs.

In addition, when a plurality of terminals exist in a group, a terminal ID may be assigned, respectively, so each terminal can recognize which of individual frames each terminal is to use.

In addition, the coexistence frame may be configured to include a start coexistence frame and an end coexistence frame, each indicating a start and an end of the individual frames. In addition, the end coexistence frame may be omitted and a start of an individual frame may be indicated only with the start coexistence frame.

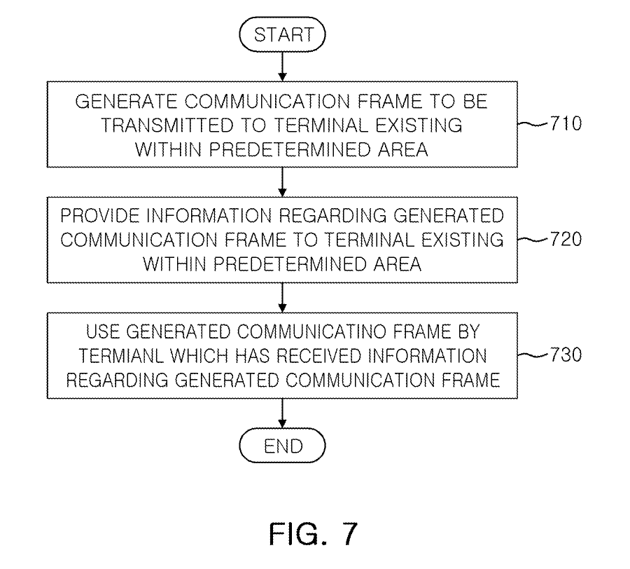

FIG. 7 is a flow chart illustrating the process of a communication method of a body area network using the method for generating a communication frame of a body area network according to an exemplary embodiment of the present invention.

With reference to FIG. 7, a communication method of a body area network using the method for generating a communication frame of a body area network according to an exemplary embodiment of the present invention includes generating a communication frame to be transmitted to a terminal existing within a predetermined area (step 710), providing information regarding the generated communication frame to the terminal existing within the predetermined area (step 720), and utilizing, by the terminal which has received information regarding the generated communication frame, the generated communication frame (step 730).

First, the generating of the communication frame (step 710) includes recognizing the number of terminals existing within the predetermined area, allocating an individual frame to be used by each of the terminals existing within the predetermined area according to the recognized number of terminals, and allocating a coexistence frame to be transmitted to every terminal existing within the predetermined area according to the recognized number of terminals.

In providing information regarding the generated communication frame to the terminal existing within the predetermined area (step 720), the information regarding the generated communication frame may be provided to the terminals existing within the predetermined area by using the coexistence frame.

In utilizing the generated communication frame by the terminal which has received the information regarding the generated communication frame (step 730), the terminal may use the individual frame.

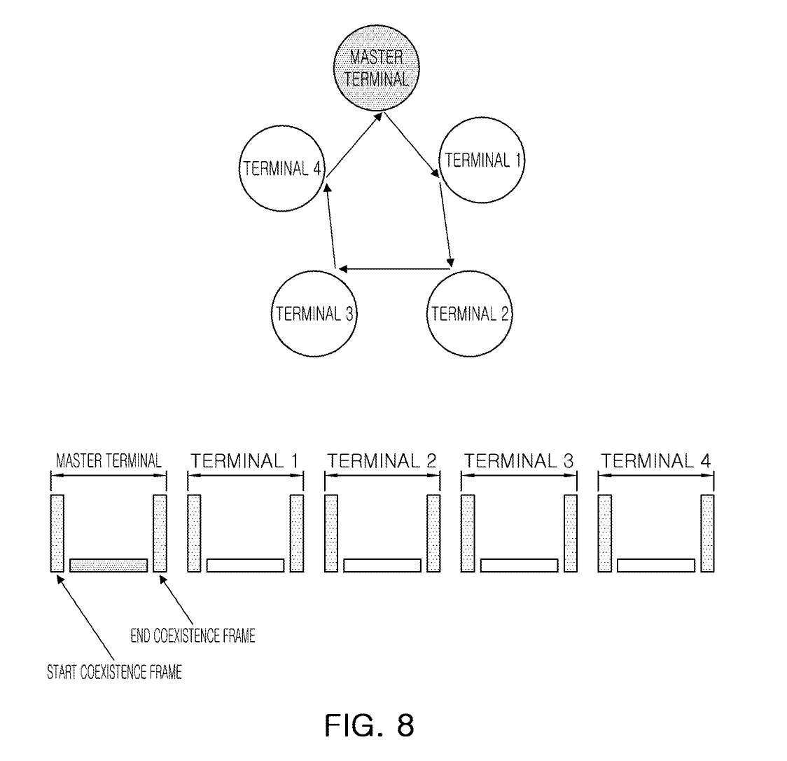

FIG. 8 is a view illustrating the communication method of a body area network using the method for generating a communication frame of a body area network according to an exemplary embodiment of the present invention.

With reference to FIG. 8, when a terminal group includes five terminals, a master terminal among the five terminals is selected, and the selected master terminal informs each of the terminals about an individual frame allocated to each of the terminals by using a start coexistence frame and an end coexistence frame.

With the individual frame information shared, the five terminals sequentially use the individual frames, starting from the master terminal, according to the discriminated start coexistence frames and end coexistence frames, and each of the terminals is able to communicate with sub-terminal(s) by using the individual frames.

Various embodiments of the foregoing communication method of the body area network will now be described.

### Embodiment 1

### Case in which Single Terminal Uses Channel

When a single terminal transmits and receives data through human body communication in its area without having any other terminal(s) approaching the single terminal, the single terminal transmits a coexistence frame and an individual frame (i.e., a data frame).

The coexistence frame includes a preamble indicating the start of communication and a group ID, and besides, the coexistence frame may include information regarding a master terminal including processor performance and the amount of transmission and reception data of the master terminal.

Regarding the group ID, because the single terminal alone uses a channel, the single terminal, which may serve as a master terminal, may be able to randomly create a group ID to use it. After the single terminal transmits a coexistence frame, if there is no response other than responses from its sub-terminals (or slave terminals) during a predetermined period of time, the single terminal determines that there are no other terminals in the channel, so it may transmit or receive a data frame or allow the sub-terminals (or the slave terminals) to use the channel.

### Embodiment 2

### Case in which Single Terminal Uses Channel and Another Terminal Approaches

When a different user is approaching, the single terminal and the other terminal may transmit and receive a synchronized frame to each other or data frames may happen to collide.

When coexistence frames are transmitted and received, the single terminal would receive a group ID different from that in use, so the single terminal may determine that a different group approaches. Thus, a master terminal and a normal terminal are determined based on information regarding the master terminal. A terminal which has better terminal processor, has a larger amount of transmission and reception data, or has the largest number of terminal IDs may be determined as the master terminal. When there are several normal terminals, the order of the normal terminals may be determined according to the order of group IDs (the number of the group IDs is random) or the information regarding the master terminal.

When the master terminal and the normal terminals are determined, a terminal ID indicating the order of each terminal in using the channel of the terminal may be added to the coexistence frame of each group. Also, the coexistence frame of each group may include a start coexistence frame and an end coexistence frame. The start coexistence frame and the end coexistence frame may have the same structure and may include a supplementary command.

The command may include information regarding a start and end of a data transmission or information regarding an end of using a channel because of a communication completion.

When the order of the terminals is determined according to the coexistence frames, the terminals perform communication sequentially. First, the master terminal uses a channel and then transmits a use end command, the normal terminals in the next order uses the channel.

### Embodiment 3

### Case in which Group of Terminals Use Channel and Terminal(s) Approaches

In a state in which a group of terminals are already formed, when a terminal (or terminals) approaches, the group is reconfigured.

When the approaching terminal is detected, a new terminal ID is requested. When it's the turn of a master terminal of the group, the master terminal designates the number of terminals of the newly configured group, for the normal terminals.

When the group first recognizes the new terminal, the master terminal requests a group ID of the normal terminals and information regarding the master terminal and then reorganizes or rearranges the group. In this case, the newly approaching terminal may be registered as a new master terminal according to information regarding the master terminal.

### Embodiment 4

### Case in which a Group of Terminals Use a Channel and Another Group of Terminals Approach

Unlike the case in which a single terminal approaches, a terminal ID is included in a coexistence frame, so each group recognizes the presence of the other group. A master of each group compares their master information and determines a master use.

### Embodiment 5

### Case in which Master Terminal or Normal Terminal of Group is Withdrawn

When terminal next to the withdrawn terminal does not receive an end coexistence frame even after the lapse of a given channel use time of the group, it requests a retransmission of the coexistence frame from a master terminal. The master terminal reorganizes the terminal group accordingly. When the withdrawn user is the master terminal, the next normal terminal of the master terminal becomes a master terminal.

As set forth above, in the method for generating a communication frame of a body area network and a communication method of a body area network using the same according to exemplary embodiments of the invention, frames synchronized between human body communication terminals can be provided, and thus, a plurality of human body communication terminals can coexist without causing a communication fault even in a narrow area.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for generating a communication frame of a body area network, the method comprising:
recognizing the number of terminals existing within a predetermined area;
allocating an individual frame to be used by each of the terminals existing within the predetermined area according to the recognized number of terminals; and
allocating a coexistence frame to be transmitted to every terminal existing within the predetermined area according to the recognized number of terminals.

2. The method of claim 1, wherein the coexistence frame comprises information regarding the allocation of the individual frame to be used by each of the terminals existing within the predetermined area.

3. The method of claim 1, wherein the coexistence frame uses any one of radio frequency identification (RFID), Bluetooth™, ZigBee™, and ultra-wide band (UWB).

4. The method of claim 1, wherein the individual frame is used for each of the terminals to communicate with a sub-terminal.

5. The method of claim 1, wherein the coexistence frame reaches a more extensive area than that of the individual frame.

6. The method of claim 1, wherein the coexistence frame comprises:
a preamble; and
a group ID identifying a group of terminals within a predetermined area.

7. The method of claim 6, wherein the coexistence frame further comprises a terminal ID indicating each of the terminals of the group.

8. A communication method of a body area network, the method comprising:
generating a communication frame to be transmitted to a terminal existing within a predetermined area;
providing information regarding the generated communication frame to the terminal existing within the predetermined area; and
utilizing, by the terminal which has received information regarding the generated communication frame, the generated communication frame.

9. The method of claim 8, wherein the generating of the communication frame comprises:
recognizing the number of terminals existing within the predetermined area;
allocating an individual frame to be used by each of the terminals existing within the predetermined area according to the recognized number of terminals; and
allocating a coexistence frame to be transmitted to every terminal existing within the predetermined area according to the recognized number of terminals.

10. The method of claim 9, wherein the coexistence frame comprises information regarding the allocation of the individual frame to be used by each of the terminals existing within the predetermined area.

11. The method of claim 9, wherein the coexistence frame uses any one of radio frequency identification (RFID), Bluetooth™, ZigBee™, and ultra-wide band (UWB).

12. The method of claim 1, wherein the individual frame is used for each of the terminals to communicate with a sub-terminal.

13. The method of claim 9, wherein the coexistence frame reaches a more extensive area than that of the individual frame.

14. The method of claim 9, wherein, in providing information regarding the generated communication frame to the terminal existing within the predetermined area, the information regarding the generated communication frame is provided by using the coexistence frame.

15. The method of claim 9, wherein, in utilizing the generated communication frame by the terminal which has received the information regarding the generated communication frame, the terminal uses the individual frame.
